(19) United States
(12) Patent Application Publication
(10) Pub. No.: US 2017/0305719 A1
(43) Pub. Date: Oct. 26, 2017

(54) DEVICE FOR CHECKING GUIDES AND METHOD FOR BALANCING AN ELEVATOR CAR

(71) Applicants: ThyssenKrupp Elevator AG, Essen (DE); ThyssenKrupp AG, Essen (DE)

(72) Inventors: Markus Jetter, Filderstadt (DE); Matthias Glück, Hochdorf (DE); Günter Reuter, Filderstadt (DE)

(73) Assignees: ThyssenKrupp Elevator AG, Essen (DE); ThyssenKrupp AG, Essen (DE)

(21) Appl. No.: 15/516,789

(22) PCT Filed: Oct. 7, 2015
(86) PCT No.: PCT/EP2015/073109

§ 371 Date: Apr. 4, 2017

(30) Foreign Application Priority Data
Oct. 9, 2014 (DE) 10 2014 220 445.3

(51) Int. Cl. B66B 11/02; B66B 7/12

(52) U.S. Cl. CPC B66B 11/026; B66B 7/1246

(57) ABSTRACT

A device for checking guides of an elevator car that can be moved along guide rails may include means for measuring contact forces of the guides on the guide rails. The device may further include an evaluation unit. The means for measuring contact forces may be configured to make measured values determined by the means for measuring contact forces available to the evaluation unit, either through wired connection or wireless connection. In some cases, the means for measuring contact forces may measure contact forces on the guide rails in at least two different directions. Also disclosed are methods for balancing elevator cars.

The present invention relates to a device for checking guides of an elevator car and to a method for balancing an elevator car by means of such a device.

### PRIOR ART

Elevator cars are guided along guide rails in elevator shafts by means of guides, in particular roller guides. In order to achieve good travel characteristics of the elevator cars, the running rollers of the roller guides must be pressed onto the guide rails only with low forces. This applies both to the traveling operation and to the standstill of the elevator car. This is of great importance, in particular for sprung roller guides.

In the event of excessively high or non-uniform contact forces, for example tires of the running rollers can flatten when at a standstill and, consequently, run non-circularly during traveling operation. Furthermore, high contact forces lead to pronounced flexing of the tires. In addition to poor travelling properties, this leads to flexing noises and early failure of the roller guides. In the extreme case, this can also lead to the detachment of the tires as a result of very high heating.

To minimize the contact forces, firstly catch frames and counterweight frames of the elevator cars should be mounted in a stress-free manner and, secondly, the elevator cars should be balanced. Furthermore, the roller guides should be used with a setting predefined by the manufacturer or set in accordance with setting instructions from the manufacturer.

Balancing the elevator car is complicated and can therefore frequently not be carried out or not be carried out sufficiently accurately. If the mass center of gravity of the elevator car is not located in the guide plane, for example following such balancing, the running rollers are loaded non-uniformly and frequently overloaded.

The balancing of elevator cars is normally carried out by suspending compensating weights at specific distances from the guide plane. In this case, it is necessary to know how much mass must be suspended at which point.

This process is normally carried out iteratively, which means that there is a risk of premature breakage and thus a non-optimal result. Theoretical calculation is possible only to a restricted extent, since the real proportions by weight of the components of the elevator car lining are frequently not known. In practice, balancing is carried out by swinging the elevator car with lower guides unrigged. However, this method is complicated and susceptible to error.

It is primarily in large constructional projects that the inner lining of the elevator cars is often carried out only at a very late time but the elevators must already previously be operated without lining or with provisional lining. In this case, it is possible for displacement of the mass center of gravity to occur. This leads to different but generally excessive forces on the roller guides.

Frequently, setting changes are performed on the roller guides. One example of this is the blocking of the swinging arm strokes of sprung roller guides by means of a travel limit. This can also lead to overloading of the running roller tires, with the aforementioned consequences.

A further example of the overloading of roller guides is aligning buckled catch or counterweight frames by means of the roller guides. For this purpose, the swinging arm strokes of the roller guides must be blocked.

Furthermore, deviations in the distance between shaft door and rail plane or elevator car door threshold and shaft door threshold are performed by displacing the elevator car by means of the roller guides. In order to prevent the elevator car from swinging back, swinging arm strokes are also blocked here.

In the event of damage to the roller guides or noise, exact analysis of the causes or compensation measures to be carried out has hitherto not been possible, since the contact force of the running roller on the rail can be measured only with high technical outlay.

It therefore desirable to specify a possible way of checking the serviceability, in particular loadings to be expected, of guides of an elevator car quickly and simply in order for example to be able to take these into account when balancing an elevator car and in order to reduce the wear of roller guides.

### DISCLOSURE OF THE INVENTION

According to the invention, a device and a method having the features of the independent patent claims are proposed. Advantageous refinements are the subject matter of the sub-claims and of the following description.

### ADVANTAGES OF THE INVENTION

The device according to the invention is used for checking guides of an elevator car that can be moved along associated guide rails, by using means for measuring contact forces of the guides on a respectively associated guide rail. The means are each designed to provide measured values acquired thereby to an evaluation unit.

By using such a device, contact forces of guides of an elevator car can be measured in a simple way. In particular, for example, a mechanic does not have to be located on or in the elevator car to measure the contact forces, which would distort the measured result. In addition, for example, a simple diagnosis can be carried out in the case of elevator cars that are not balanced or have subsequently been modified. It is in particular possible to measure all the relevant contact forces of all the guides simultaneously.

The means for measuring the contact forces are preferably each designed to measure the contact forces on the respectively associated guide rail in at least two different, in particular mutually perpendicular, directions. It is therefore likewise possible to measure all the relevant contact forces simultaneously. In particular, it is therefore possible to check guides which, for example, comprise multiple running rollers for different directions.

Advantageously, the means for measuring the contact forces can each be fitted detachably to the associated guide rail, to be specific in particular at least partly between the guide rail and a running roller of the guide. As a result, the means can be fitted for the duration of a measurement and then removed again.

In addition, in this way the guides of the elevator car can remain unchanged during the measuring of the contact forces, by which means possible inaccuracies which would result as a result of dismantled or rotated running rollers or even entire guides, are avoided. In addition, the installation effort for removing and installation, and also the subsequent setting of the running rollers, is avoided. As a result, the device can also be used for elevator cars and guides from different manufacturers. In addition, subsequent checking can be carried out, for example in the event of a modification to the lining of the elevator car.

The means for measuring the contact forces preferably comprise force measuring films. Force measuring films are very thin and therefore find space between the running roller and the corresponding part of the guide rail. On one side, the force measuring films can, for example, be provided with a magnetic coating or another adhesive coating. These can thus be fitted and removed again quickly and, above all, without any tools. Force measuring films, as very thin sensors, additionally increase the contact forces only insubstantially and are therefore particularly suitable.

Alternatively, the means for measuring the contact forces each have at least one force transducer, in particular a force transducer for each of the directions, wherein the means can in particular each be introduced in a removable manner into a guide constructed as an emergency guide. It is also conceivable to design the means as separate guides, which can be fitted to the elevator car. In this way, too, all the contact forces can be determined simultaneously. In addition, force transducers, for example what are known as load cells, operate very accurately.

It is particularly advantageous if the means for measuring the contact forces each comprise a radio transmission unit, by means of which the measured values can be transmitted to the evaluation unit. Therefore, rapid and simple handling of the device can be achieved, since no cable connections have to be taken into account.

Alternatively, the means for measuring the contact forces can each be connected to the evaluation unit by means of a cable connection. This has the advantage that no radio transmission unit is needed, and thus saves costs.

Expediently, the device also comprises an evaluation unit, which comprises processing means and display means and is designed, on the basis of measured values which are provided by the means for measuring the contact forces and contact forces calculated therefrom, to determine and display a weight distribution of the elevator that changes the contact forces, in particular a setting of adjustable weights on the elevator car. Such an evaluation unit can particularly advantageously be portable. This can be, for example, a laptop, a tablet computer or a smart phone with appropriate computer program (for example a so-called App). However, a specific device which is tailored exactly to the requisite needs is also conceivable. The calculation of the weight distribution can be carried out by means of suitable mathematical models. In particular, specific data from the respective elevator car can be taken into account. The weight distribution is expediently such that the balancing of the elevator car is optimal, i.e. that all contact forces are as far as possible of equal size. In addition, for example, an algorithm can be provided in the computer program, with which other problem causes such as, for example stresses or blocking, can be detected and thus eliminated.

The method according to the invention is used for balancing an elevator car which can be moved by means of guides along associated guide rails, by means of a device according to the invention, comprising the following steps:

fitting the means for measuring the contact forces, determining and displaying the weight distribution of the elevator car that changes the contact forces, by means of the evaluation unit, and carrying out corrective measures for adapting the elevator car to the weight distribution determined. Loading or overloading of the guides, in particular the rollers of guides, can therefore be detected and corrected very simply and quickly. This additionally leads to a saving in costs as a result of the shorter setting times of the elevator car. The traveling quality of the elevator is therefore increased and ensured in the long term, which also establishes higher customer satisfaction. In addition, the service life of the guide, in particular the rollers, is therefore increased. If the results are documented, then it is also possible to establish later whether, for example, subsequent changes have been made to the lining of the elevator car. In addition, the method according to the invention permits rapid, simple and accurate balancing of the elevator car in virtually any desired position to which the elevator car can be moved in the elevator shaft.

Preferably, following the fitting of the means for measuring the contact forces and before the determination of the weight distribution, individuals in or on the elevator car leave the elevator car. Therefore, inaccuracies in the measurement can be reduced, since hitherto individuals, in particular a mechanic, would have to be located on the elevator roof during the setting and constitute an additional weight. With a method according to the invention, this is no longer necessary.

It is also expedient if the means for measuring the contact forces are removed after the corrective measures have been carried out. Therefore, these means do not constitute any impairment to the operation of the elevator and can be used for other elevators.

Further advantages and refinements of the invention can be gathered from the description and the appended drawing.

It goes without saying that the features mentioned above and those still to be explained below can be used not only in the respectively specified combination but also in other combinations or on their own without departing from the scope of the present invention.

The invention is illustrated schematically in the drawing by using exemplary embodiments and will be described extensively below with reference to the drawing.

### FIGURE DESCRIPTION

FIG. 1 shows, schematically, an elevator car with a device according to the invention in a preferred configuration.

FIG. 2 shows, schematically, a guide of an elevator car with a device according to the invention in a preferred configuration.

FIG. 3 shows, schematically, a guide of an elevator car with a device according to the invention in a further preferred configuration.

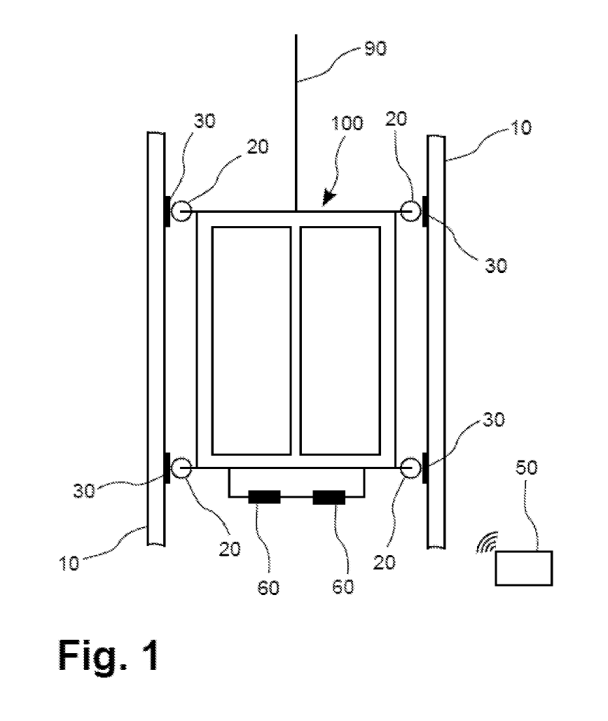

In FIG. 1, an elevator car 100 in an elevator shaft with guide rails 10 and a device according to the invention in a preferred configuration is illustrated schematically. The elevator car 100 has four guides 20 formed as roller guides, by means of which it is guided along the guide rails 10. The elevator car 100 is held by a supporting means 90.

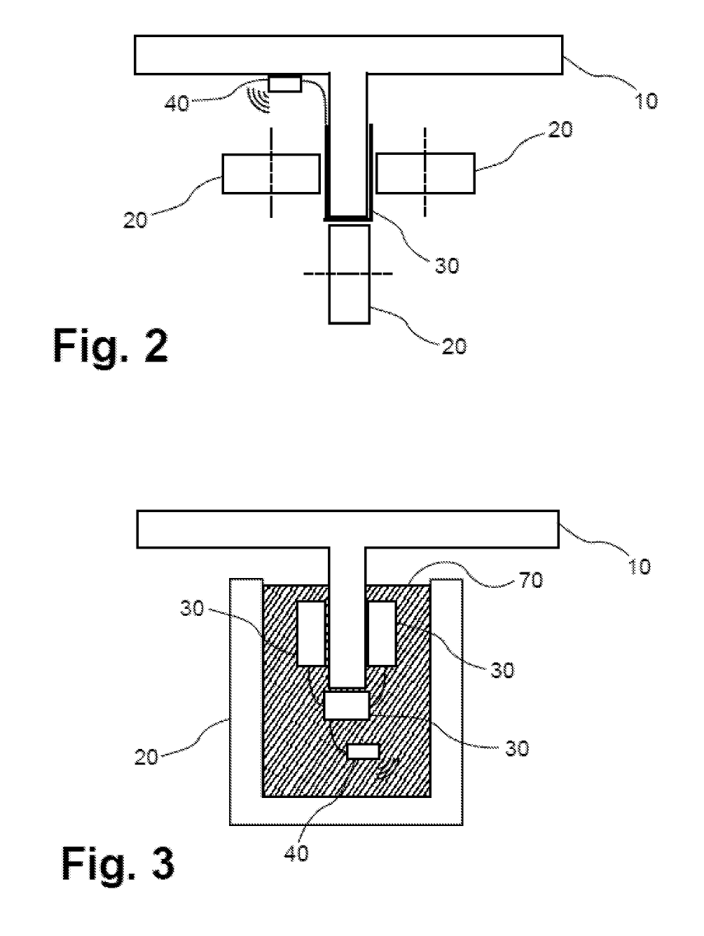

Four means 30 for measuring contact forces are fitted to the guide rails 10. According to this embodiment, the means 30 are formed as force measuring films. They are each placed on the guide rails 10 in such a way that they can pick up and measure the contact forces of the roller guides 20. For a more detailed illustration of the means 30, reference should be made to FIG. 2. Also shown is an evaluation unit 50, which is connected to the means 30 via a radio connection.

The evaluation unit 50 can be a specific device for evaluating the contact forces. However, for example, the use of a laptop, a tablet computer or a smart phone having an appropriate computer program, in particular a so-called App, is also expedient.

Also illustrated on the underside of the elevator car 100, by way of example, are two displaceable weights 60, by means of which the weight distribution of the elevator car 100 can be set. Another number of such weights 60, for example three or four, is also conceivable.

In FIG. 2, a cross section of a guide rail 10 with a roller guide 20 is shown. The roller guide 20 comprises three rollers, which press on the guide rail 10 in different directions.

A means 30 formed as a force measuring film is fitted to the guide rail 10. This can be, for example, a force measuring film which is bent appropriately or else three individual force measuring films which are appropriately connected to one another. For the detachable attachment to the guide rail 10, the force measuring film has, for example, a magnetic coating on one side. However, other coatings, for example adhesive coatings, are also conceivable.

Here, it should also be noted that the force measuring films including the coating are so thin that they readily find space between the rollers of the roller guides 20 and the guide rail 10 and also do not substantially change the measured result, because of the low application. Care must also be taken that the force measuring film is not stripped off by catch devices.

The means 30 also comprise a radio transmission unit 40, by means of which a radio link to the evaluation unit 50 can be produced. Such a radio connection can, for example, be made via a so-called Bluetooth connection.

In order to perform the method according to the invention, the means 30 including the radio transmission unit 40 are each fitted to the appropriate points on the guide rail, as shown by way of example in FIG. 1. Expediently, the means 30 are each fitted directly above or below the guides 20, and the elevator car 100 is then moved appropriately.

After all individuals have left the elevator car 100 (that is to say in particular after a mechanic has left the roof of the elevator car), an up-to date and precise distribution of the contact forces can be measured by means of the evaluation unit 50. By means of the evaluation unit 50, an optimal weight distribution of the elevator car 100 can then be determined, so that all the contact forces are distributed optimally. For this purpose, an optimum setting of the weights 60 can expediently be specified or proposed by the evaluation unit 50, which setting is then adjusted appropriately.

It should also be noted that such balancing can be carried out at each position to which the elevator car can move. Expedient, however, is one floor, for example, with a longer waiting time of the elevator car, since loadings of the guides manifest themselves most quickly there. In addition, the mass of a suspension cable on the elevator car 100 should also be taken into account.

Following the balancing, the elevator car can be moved down again from the means 30, and the means 30 can be removed.

In FIG. 3, a cross section of a further preferred configuration of the device according to the invention is shown. An inlay 70, in which in turn the means 30 for measuring the contact force of the guide 20 on the guide rail 10 are introduced, is introduced into the guide 20, formed as an emergency guide. The means 30 comprise three force transducers, for example so-called load cells. The three force transducers are connected to a radio transmission unit 40, via which they are connected to an evaluation unit.

The force transducers here, as well as the force measuring films in FIG. 2, measure three different directions of the contact forces. These directions expediently correspond to the directions in which rollers of a regular roller guide bear on the guide rail. During the performance of the method according to the invention, the difference here, as opposed to the use of a device shown in FIG. 2, is that the means 30 are introduced in the respective inlay 70 into the emergency guides, which are usually arranged close to the roller guides. Following the balancing, the inlays 70 are then removed from the emergency guides again.

1.-12. (canceled)

13. A device for checking guides of an elevator car that can be moved along guide rails, the device comprising:
means for measuring contact forces of the guides on the guide rails, wherein the means for measuring contact forces are detachably fitted to the guide rails; and
an evaluation unit, wherein the means for measuring contact forces are configured to make measured values determined by the means for measuring contact forces available to the evaluation unit.

14. The device of claim 13 wherein the means for measuring contact forces are configured to measure contact forces on the guide rails in at least two different directions.

15. The device of claim 13 wherein the means for measuring contact forces are at least partly fitted between the guide rails and running rollers of the guides.

16. The device of claim 13 wherein the means for measuring contact forces comprise force measuring films.

17. The device of claim 13 wherein the means for measuring contact forces each include at least one force transducer.

18. The device of claim 17 wherein the means for measuring contact forces are either removably disposed into guides configured as emergency guides or fitted to the elevator car as separate guides.

19. The device of claim 13 wherein the means for measuring contact forces comprise radio transmission units that transmit the measured values to the evaluation unit.

20. The device of claim 13 wherein the means for measuring contact forces are connectable to the evaluation unit by a cable connection.

21. The device of claim 13 wherein the evaluation unit comprises a processing means and a display means, wherein based on the measured values and the contact forces calculated therefrom the evaluation unit is configured to determine and display a weight distribution of the elevator car that changes the contact forces.

22. The device of claim 21 wherein the weight distribution that is determined and displayed by the evaluation unit comprises a setting for adjustable weights on the elevator car.

23. A method for balancing an elevator car that can be moved by guides along guide rails, wherein the balancing involves a device comprising means for measuring contact forces of the guides on the guide rails, wherein the means for measuring contact forces are detachably fitted to the guide rails, the device further comprising an evaluation unit, wherein the means for measuring contact forces are configured to make measured values determined by the means for measuring contact forces available to the evaluation unit, wherein the evaluation unit comprises a processing means and a display means, wherein based on the measured values and the contact forces calculated therefrom the evaluation unit is configured to determine and display a weight distribution of the elevator car that changes the contact forces, with the weight distribution comprising a setting for adjustable weights on the elevator car, the method comprising:
fitting the means for measuring contact forces;
determining and displaying the weight distribution of the elevator car that changes the contact forces by way of the evaluation unit; and
performing corrective measures to adapt the elevator car to the determined weight distribution.

24. The method of claim 23 wherein the weight distribution is determined and displayed after the means for measuring contact forces have been fitted and after one or more individuals in or on the elevator car have left the elevator car.

25. The method of claim 23 further comprising removing the means for measuring contact forces after the corrective measures have been performed.
